(19) United States
(12) Patent Application Publication
(10) Pub. No.: US 2025/0251575 A1
(43) Pub. Date: Aug. 7, 2025

(54) OPTICAL IMAGING LENS

(71) Applicant: Calin Technology Co., Ltd., Taichung City (TW)

(72) Inventors: FUN-RU LIN, Taichung City (TW); SHU-CHUAN HSU, Taichung City (TW); YUE-JHANG LI, Taichung City (TW)

(73) Assignee: Calin Technology Co., Ltd., Taichung City (TW)

(21) Appl. No.: 18/752,691

(22) Filed: Jun. 24, 2024

(30) Foreign Application Priority Data
Feb. 7, 2024 (TW) 113104977

(51) Int. Cl. G02B 13/00; G02B 9/64

(52) U.S. Cl. CPC G02B 13/0045; G02B 9/64; G02B 13/0055

(57) ABSTRACT

An optical imaging lens, in order from an object side to an image side along an optical axis, includes a first lens assembly, an aperture, and a second lens assembly. The first lens assembly consists of, in order from the object side to the image side along the optical axis, a first lens having negative refractive power, a second lens having negative refractive power, and a third lens having positive refractive power. The second lens assembly consists of, in order from the object side to the image side along the optical axis, a fourth lens having positive refractive power, a fifth lens having positive refractive power, a sixth lens having negative refractive power, and a seventh lens having positive refractive power.

### BACKGROUND OF THE INVENTION

### Technical Field

The present invention generally relates to an optical image capturing system, and more particularly to an optical imaging lens, which provides a better optical performance of low distortion and high image quality.

### Description of Related Art

In recent years, with popularization in portable electronic devices having camera functionalities, the demand for an optical image capturing system is raised gradually. The ordinary optical image capturing system is selected from a charge-coupled device (CCD) or a complementary metal-oxide-semiconductor sensor (CMOS Sensor). Besides, as advanced semiconductor manufacturing technology enables the minimization of the pixel size of the image sensing device, the development of the optical image capturing system towards the field of high pixels. Moreover, with the advancement in drones and driverless autonomous vehicles, Advanced Driver Assistance System (ADAS) plays an important role in the field of vehicle safety, collecting real-time environmental information through various lenses and sensors to provide the comprehensive insights of the driver. Furthermore, as the automotive lens changes with the temperature of an external application environment, the temperature requirements of the image quality of the automotive lens also increase. Therefore, the requirement for high imaging quality is rapidly raised.

Good imaging lenses generally have the advantages of low distortion, high resolution, etc. In practice, small size and cost must be considered. Therefore, it is a big problem for designers to design a lens with good imaging quality under various constraints.

### BRIEF SUMMARY OF THE INVENTION

In view of the reasons mentioned above, the primary objective of the present invention is to provide an optical imaging lens that provides a high image quality.

The present invention provides an optical imaging lens, in order from an object side to an image side along an optical axis, including a first lens assembly, an aperture, and a second lens assembly, wherein the first lens assembly consists of, in order from the object side to the image side along the optical axis, a first lens having negative refractive power, a second lens having negative refractive power, and a third lens having positive refractive power. An object-side surface of the first lens is a concave surface, and an image-side surface of the first lens is a convex surface. The second lens assembly consists of, in order from the object side to the image side along the optical axis, a fourth lens having positive refractive power, a fifth lens having positive refractive power, a sixth lens having negative refractive power, and a seventh lens having positive refractive power.

The present invention further provides an optical imaging lens, in order from an object side to an image side along an optical axis, including a first lens assembly, an aperture, and a second lens assembly, wherein the first lens assembly consists of, in order from the object side to the image side along the optical axis, a first lens having negative refractive power, a second lens, and a third lens. An object-side surface of the first lens is a concave surface, and an image-side surface of the first lens is a convex surface. An image-side surface of the second lens and an object-side surface of the third lens are adhered to form a compound lens having positive refractive power. The second lens assembly consists of, in order from the object side to the image side along the optical axis, a fourth lens having positive refractive power, a fifth lens, a sixth lens, and a seventh lens having positive refractive power, wherein an image-side surface of the fifth lens and an object-side surface of the sixth lens are adhered to form a compound lens having negative refractive power.

The effect of the present invention lies in arranging at least seven lenses into an optical assembly for the optical imaging lens. In addition, the arrangement of the refractive powers and the conditions of the optical imaging lens of the present invention could achieve the effect of high image quality.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1A is a schematic view of the optical imaging lens according to a first embodiment of the present invention;

FIG. 1B is a diagram showing the longitudinal chromatic aberration of the optical imaging lens according to the first embodiment of the present invention;

FIG. 1C is a diagram showing the lateral chromatic aberration of the optical imaging lens according to the first embodiment of the present invention;

FIG. 2A is a schematic view of the optical imaging lens according to a second embodiment of the present invention;

FIG. 2B is a diagram showing the longitudinal chromatic aberration of the optical imaging lens according to the second embodiment of the present invention;

FIG. 2C is a diagram showing the lateral chromatic aberration of the optical imaging lens according to the second embodiment of the present invention;

FIG. 3A is a schematic view of the optical imaging lens according to a third embodiment of the present invention;

FIG. 3B is a diagram showing the longitudinal chromatic aberration of the optical imaging lens according to the third embodiment of the present invention; and

FIG. 3C is a diagram showing the lateral chromatic aberration of the optical imaging lens according to the third embodiment of the present invention.

### DETAILED DESCRIPTION OF THE INVENTION

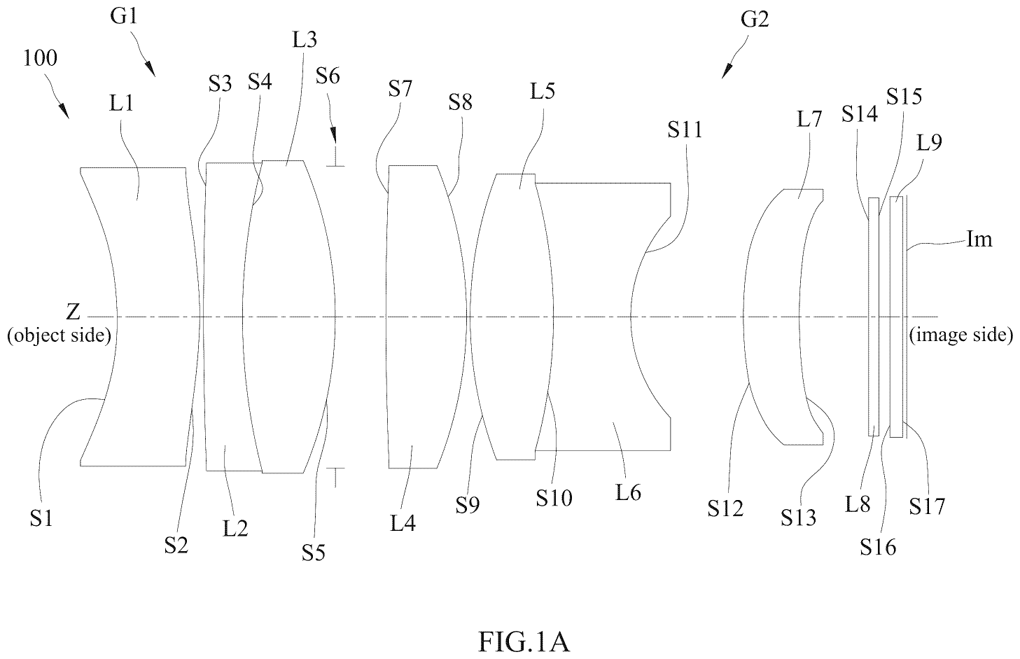

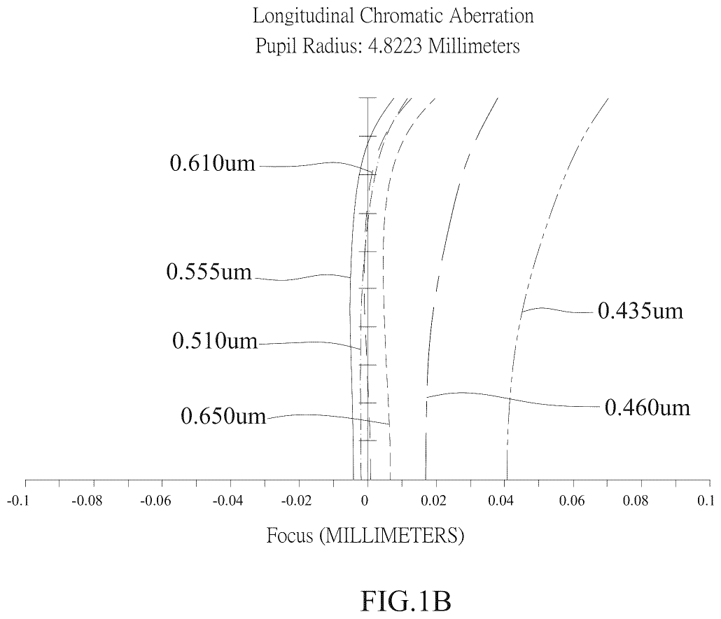

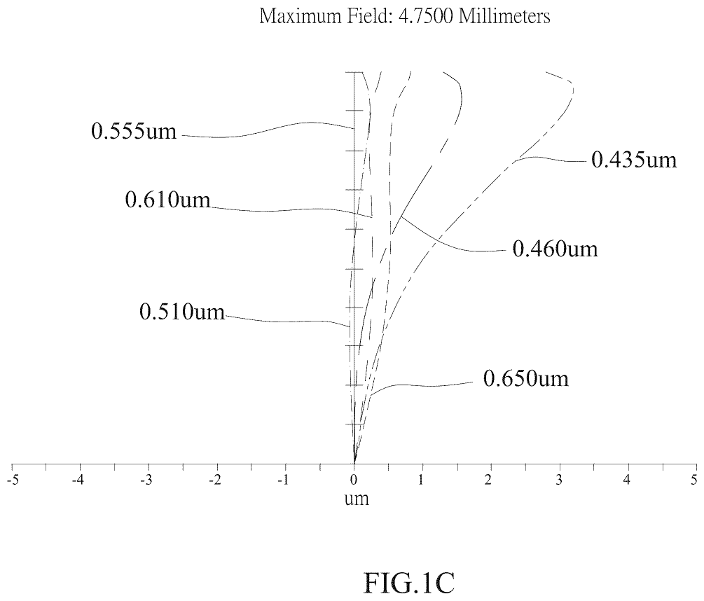

An optical imaging lens 100 according to a first embodiment of the present invention is illustrated in FIG. 1A, which includes, in order along an optical axis Z from an object side to an image side, a first lens assembly G1, an aperture S6, and a second lens assembly G2. In the first embodiment, the optical imaging lens 100 includes at least seven lenses, wherein the first lens assembly G1 consists of, in order along the optical axis Z from the object side to the image side, a first lens L1, a second lens L2, and a third lens L3. The second lens assembly G2 consists of, in order along the optical axis Z from the object side to the image side, a fourth lens LA, a fifth lens L5, a sixth lens L6, and a seventh lens L7.

The first lens L1 has negative refractive power; an object-side surface S1 of the first lens L1 is a concave surface, and an image-side surface S2 of the first lens L1 is a convex surface; both of the object-side surface S1 and the image-side surface S2 of the first lens L1 are aspheric surfaces.

The second lens L2 has negative refractive power; an object-side surface S3 of the second lens L2 is a convex surface, and an image-side surface S4 of the second lens L2 is a concave surface; both of the object-side surface S3 and the image-side surface S4 of the second lens L2 are spherical surfaces.

The third lens L3 is a biconvex lens with positive refractive power, wherein both of an object-side surface S4 and an image-side surface S5 of the third lens L3 are spherical surfaces. In the first embodiment, the object-side surface S4 of the third lens L3 and the image-side surface S4 of the second lens L2 are adhered to form a compound lens having positive refractive power.

The fourth lens LA is a biconvex lens with positive refractive power, wherein both of an object-side surface S7 and an image-side surface S8 of the fourth lens LA are spherical surfaces.

The fifth lens L5 is a biconvex lens with positive refractive power, wherein both of an object-side surface S9 and an image-side surface S10 of the fifth lens L5 are spherical surfaces.

The sixth lens L6 is a biconcave lens with negative refractive power, wherein an object-side surface S10 of the sixth lens L6 is a spherical surface, and an image-side S11 of the sixth lens L6 is an aspheric surface. In the first embodiment, the object-side surface S10 of the sixth lens L6 and the image-side surface S10 of the fifth lens L5 are adhered to form a compound lens having negative refractive power.

The seventh lens L7 has positive refractive power; an object-side surface S12 of the seventh lens L7 is a convex surface, and an image-side surface S13 of the seventh lens L7 is a concave surface; the object-side surface S12 of the seventh lens L7 is an aspheric surface, and the image-side surface S13 of the seventh lens L7 is a spherical surface.

Additionally, the optical imaging lens 100 further includes an infrared filter L8 and a protective glass L9, wherein the infrared filter L8 forms an object-side surface S14 facing the object side and an image-side surface S15 facing the image side. The infrared filter L8 is disposed on one side of the image-side surface S13 of the seventh lens L7, thereby restricting infrared rays passing through the optical imaging lens 100 to improve the quality and fidelity of the image. The protective glass L9 forms an object-side surface S16 facing the object side and an image-side surface S17 facing the image side. The protective glass L9 is disposed on one side of the infrared filter L8 and is located between the infrared filter L8 and an image plane Im to protect the infrared filter L8.

In order to keep the optical imaging lens 100 in good optical performance and high imaging quality, in the first embodiment, the optical imaging lens 100 satisfies:

$$- 0.459 < F / f 1 < - 0.435 ; \qquad ( 1 )$$

$$- 0.385 < F / f 2 < - 0.362 ; \qquad ( 2 )$$

$$1. < F / f 3 < 1.2 ; \qquad ( 3 )$$

$$0.6 < F / f 4 < 0.8 ; \qquad ( 4 )$$

$$1.155 < F / f 5 < 1.205 ; \qquad ( 5 )$$

$$- 2.523 < F / f 6 < - 2.412 ; \qquad ( 6 )$$

$$0.249 < F / f 7 < 0.286 ; \qquad ( 7 )$$

$$0.455 < F / fg 1 < 0.471 ; \qquad ( 8 )$$

$$0.335 < F / fg 2 < 0.367 . \qquad ( 9 )$$

wherein F is a focal length of the optical imaging lens 100; f1 is a focal length of the first lens L1; f2 is a focal length of the second lens L2; f3 is a focal length of the third lens L3; f4 is a focal length of the fourth lens L4; f5 is a focal length of the fifth lens L5; f6 is a focal length of the sixth lens L6; f7 is a focal length of the seventh lens L7; fg1 is a focal length of the first lens assembly G1; fg2 is a focal length of the second lens assembly G2.

Parameters of the optical imaging lens 100 of the first embodiment of the present invention are listed in following Table 1, including the focal length F of the optical imaging lens 100 (also called an effective focal length (EFL)), a F-number (Fno), a maximal field of view (FOV), a radius of curvature (R) of each lens, a distance (D) between each surface and the next surface on the optical axis Z, a refractive index (Nd) of each lens, an Abbe number (Vd) of each lens, the focal length of each lens, wherein a unit of the focal length, the radius of curvature, and the distance is millimeter (mm). The data listed below are not a limitation of the present invention, wherein the parameters that could be appropriate changed by one with ordinary skill in the art after referring the present invention should still fall within the scope of the present invention.

TABLE 1
F = 15.21 mm; Fno = 1.67; FOV = 34.78 deg

| | | | | | | Cemented | | |
|---|---|---|---|---|---|---|---|---|
| | | | | | Focal | focal | Focal | |
| Surface | R(mm) | D(mm) | Nd | Vd | length | length | length | Note |
| S1 | −10.158 | 3.180 | 1.808 | 40.549 | −33.469 | | 33.246 | First |
| | | | | | | | | lens L1 |
| S2 | −18.490 | 0.161 | | | | | | |
| S3 | 152.486 | 1.510 | 1.689 | 31.157 | −40.744 | 20.466 | | Second |
| | | | | | | | | lens L2 |
| S4 | 23.745 | 3.587 | 1.699 | 51.112 | 14.008 | | | Third |
| | | | | | | | | lens L3 |
| S5 | −15.747 | 0.023 | | | | | | |
| S6 | INFINITY | 1.960 | | | | | | Aperture |
| | | | | | | | | S6 |
| S7 | 134.922 | 3.117 | 1.648 | 53.024 | 21.949 | | 42.045 | Fourth |
| | | | | | | | | lens L4 |
| S8 | −15.839 | 0.140 | | | | | | |
| S9 | 15.410 | 3.225 | 1.699 | 51.112 | 12.874 | −18.386 | | Fifth |
| | | | | | | | | lens L5 |
| S10 | −19.984 | 3.023 | 1.689 | 31.157 | −6.141 | | | Sixth |
| | | | | | | | | lens L6 |
| S11 | 5.748 | 4.345 | | | | | | |
| S12 | 14.810 | 2.205 | 1.583 | 59.386 | 54.329 | | | Seventh |
| | | | | | | | | lens L7 |
| S13 | 26.200 | 2.687 | | | | | | |
| S14 | INFINITY | 0.400 | 1.517 | 64.167 | | | | Infrared |
| | | | | | | | | Filter L8 |
| S15 | INFINITY | 0.424 | | | | | | |
| S16 | INFINITY | 0.500 | 1.517 | 64.167 | | | | Protective |
| | | | | | | | | Glass L9 |
| S17 | INFINITY | 0.150 | | | | | | |
| Im | INFINITY | 0.000 | | | | | | Image |
| | | | | | | | | Plane Im |

It could be seen from Table 1 that, in the first embodiment, the focal length F of the optical imaging lens 100 is 15.21 mm, and the Fno is 1.67, and the FOV is 34.78 degrees, wherein the focal length f1 of the first lens L1 is −33.469 mm; the focal length f2 of the second lens L2 is −40.744 mm; the focal length f3 of the third lens L3 is 14.008 mm; the focal length f4 of the fourth lens LA is 21.949 mm; the focal length f5 of the fifth lens L5 is 12.874 mm; the focal length f6 of the sixth lens L6 is −6.141 mm; the focal length f7 of the seventh lens L7 is 54.329 mm; the focal length f23 (cemented focal length) of the compound lens formed by adhering the second lens L2 and the third lens L3 is 20.466 mm; the focal length f56 (cemented focal length) of the compound lens formed by adhering the fifth lens L5 and the sixth lens L6 is −18.386 mm; the focal length fg1 of the first lens assembly G1 is 33.246 mm; the focal length fg2 of the second lens assembly G2 is 42.045 mm.

Additionally, based on the above detailed parameters, detailed values of the aforementioned conditions (1) to (9) in the first embodiment are as follows:

$$F / f 1 = - 0.455 ; \qquad ( 1 )$$

$$F / f 2 = - 0.373 ; \qquad ( 2 )$$

$$F / f 3 = 1.086 ; \qquad ( 3 )$$

$$F / f 4 = 0.693 ; \qquad ( 4 )$$

$$F / f 5 = 1.182 ; \qquad ( 5 )$$

$$F / f 6 = - 2.478 ; \qquad ( 6 )$$

$$F / f 7 = 0.28 ; \qquad ( 7 )$$

$$F / fg 1 = 0.458 ; \qquad ( 8 )$$

$$F / fg 2 = 0.359 . \qquad ( 9 )$$

With the parameters from Table 1, in the first embodiment, the focal length of each lens, the focal length fg1 of the first lens assembly G1, and the focal length fg2 of the second lens assembly G2 satisfy the aforementioned conditions (1) to (9) of the optical imaging lens 100.

Additionally, in the first embodiment, the optical imaging lens 100 further satisfies:

$$0.9 < F / R 9 < 1.1 ; \qquad ( 10 )$$

$$2.5 < F / R 11 < 2.7 ; \qquad ( 11 )$$

$$0.104 < fg 1 / ( R 1 + R 2 + R 3 + R 4 + R 5 + R 7 + R 8 + R 9 + R 10 + R 11 + R 12 + R 13 ) < 0.115 ; \qquad ( 12 )$$

$$0.141 < fg 2 / ( R 1 + R 2 + R 3 + R 4 + R 5 + R 7 + R 8 + R 9 + R 10 + R 11 + R 12 + R 13 ) < 0.148 ; \qquad ( 13 )$$

$$0.048 < F / ( R 1 + R 2 + R 3 + R 4 + R 5 + R 7 + R 8 + R 9 + R 10 + R 11 + R 12 + R 13 ) < 0.053 ; \qquad ( 14 )$$

wherein F is the focal length of the optical imaging lens 100; R1 is a radius of curvature of the object-side surface S1 of the first lens L1; R2 is a radius of curvature of the image-side surface S2 of the first lens L1; R3 is a radius of curvature of the object-side surface S3 of the second lens L2; R4 is a radius of curvature of a surface formed by correspondingly adhering the image-side surface S4 of the second lens L2 and the object-side surface S4 of the third lens L3; R5 is a radius of curvature of the image-side surface S5 of the third lens L3; R7 is a radius of curvature of the object-side surface S7 of the fourth lens LA; R8 is a radius of curvature of the image-side surface S8 of the fourth lens LA; R9 is a radius of curvature of the object-side surface S9 of the fifth lens L5; R10 is a radius of curvature of a surface formed by correspondingly adhering the image-side surface S10 of the fifth lens L5 and the object-side surface S10 of the sixth lens L6; R11 is a radius of curvature of the image-side surface S11 of the sixth lens L6; R12 is a radius of curvature of the object-side surface S12 of the seventh lens L7; R13 is a radius of curvature of the image-side surface S13 of the seventh lens L7; fg1 is the focal length of the first lens assembly G1; fg2 is the focal length of the second lens assembly G2.

Based on the detailed parameters of Table 1, detailed values of the aforementioned conditions (10) to (14) in the first embodiment are as follows:

$$F / R 9 = 0.987 ; \qquad ( 10 )$$

$$F / R 11 = 2.647 ; \qquad ( 11 )$$

$$fg 1 / ( R 1 + R 2 + R 3 + R 4 + R 5 + R 7 + R 8 + R 9 + R 10 + R 11 + R 12 + R 13 ) = 0.113 ; \qquad ( 12 )$$

$$fg 2 / ( R 1 + R 2 + R 3 + R 4 + R 5 + R 7 + R 8 + R 9 + R 10 + R 11 + R 12 + R 13 ) = 0.145 ; \qquad ( 13 )$$

$$F / ( R 1 + R 2 + R 3 + R 4 + R 5 + R 7 + R 8 + R 9 + R 10 + R 11 + R 12 + R 13 ) = 0.052 . \qquad ( 14 )$$

With the parameters from Table 1, each of the related values in the first embodiment satisfies the aforementioned conditions (10) to (14) of the optical imaging lens 100.

Moreover, an aspheric surface contour shape Z of each of the object-side surface S1 of the first lens L1, the image-side surface S2 of the first lens L1, the image-side surface S11 of the sixth lens L6, and the object-side surface S12 of the seventh lens L7 according to the first embodiment could be obtained by following formula:

$$Z = \frac{{ch}^{2}}{1 + \sqrt{1 - ( 1 + k ) {c}^{2} {h}^{2}}} + {A}_{2} {h}^{2} + {A}_{4} {h}^{4} + {A}_{6} {h}^{6} + {A}_{8} {h}^{8} + {A}_{10} {h}^{10} + {A}_{12} {h}^{12} + {A}_{14} {h}^{14} + {A}_{16} {h}^{16}$$

wherein Z is aspheric surface contour shape; c is reciprocal of radius of curvature; h is half the off-axis height of the surface; k is conic constant; A2, A4, A6, A8, A10, A12, A14 and A16 respectively represents different order coefficient of h.

In the optical imaging lens 100 according to the first embodiment, the conic constant k of each of the aspheric surfaces and the different order coefficient of A2, A4, A6, A8, A10, A12, A14, and A16 are listed in following Table 2:

TABLE 2

| Surface | S1 | S2 | S11 | S12 |
|---|---|---|---|---|
| k | −8.14585E−01 | −3.99573E+00 | 6.22554E+00 | 2.86567E+01 |
| A2 | 0 | 0 | 0 | 0 |
| A4 | 6.87949E−05 | 2.05491E−04 | 5.15340E−04 | 6.35954E−04 |
| A6 | 3.55395E−06 | 2.99647E−06 | 8.89619E−07 | −2.1825E−05 |
| A8 | −7.43748E−08 | −2.20033E−08 | −3.94246E−07 | 4.11895E−06 |
| A10 | 1.27168E−09 | 0 | 8.27014E−08 | −5.14614E−07 |
| A12 | −4.29521E−11 | 0 | −4.8028E−09 | 4.09794E−08 |
| A14 | 8.62501E−13 | 0 | 1.33613E−10 | −1.69393E−09 |
| A16 | −6.61054E−15 | 0 | −1.20292E−12 | 2.95791E−11 |

Taking optical simulation data to verify the imaging quality of the optical imaging lens 100, wherein FIG. 1B is a diagram showing the longitudinal chromatic aberration according to the first embodiment. From FIG. 1B, it could be observed that the curves formed by each wavelength are close to one another, thereby significantly enhancing chromatic aberration. The skewness of each curve shows that the deviation of the imaging points of off-axis rays is controlled within the range of −0.01 to 0.07 millimeters. Therefore, in the first embodiment, chromatic aberration for different wavelengths is significantly improved.

The lateral chromatic aberration according to the first embodiment is illustrated in FIG. 1C. From FIG. 1C, it could be observed that the lateral chromatic aberration of both the shortest wavelength and the longest wavelength irradiating on the image plane is less than 3.5 micrometers, indicating that the optical imaging lens 100 has low lateral chromatic aberration. The rays of different wavelengths tend to converge at the image plane, thereby improving color accuracy and image quality.

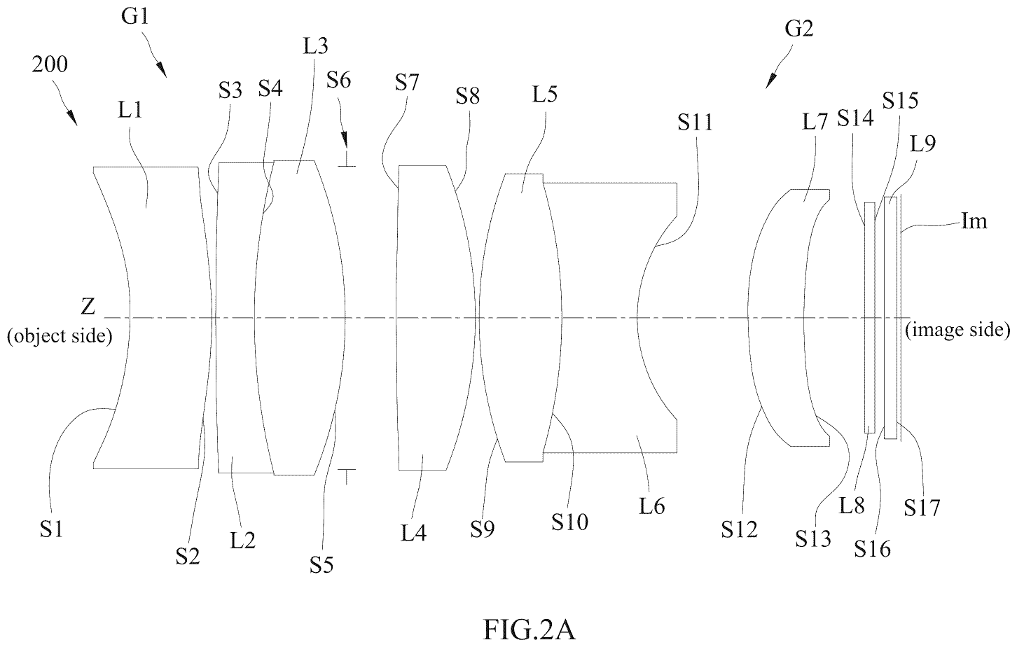

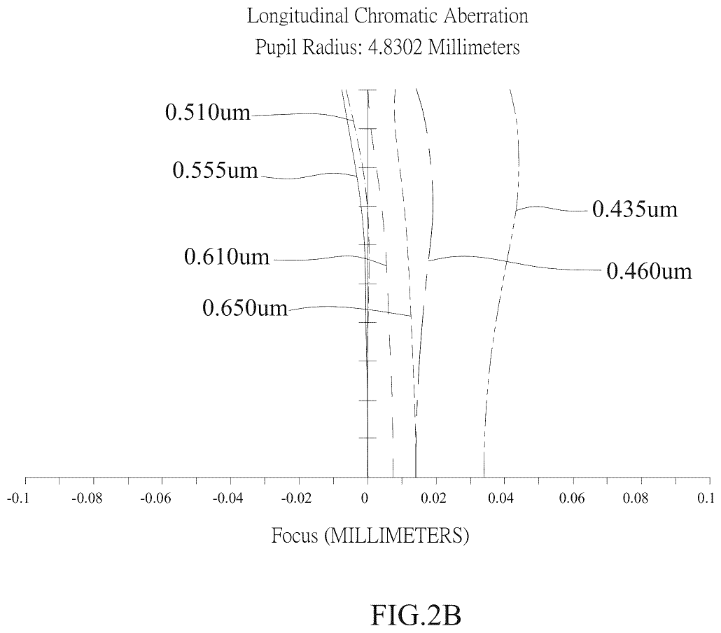

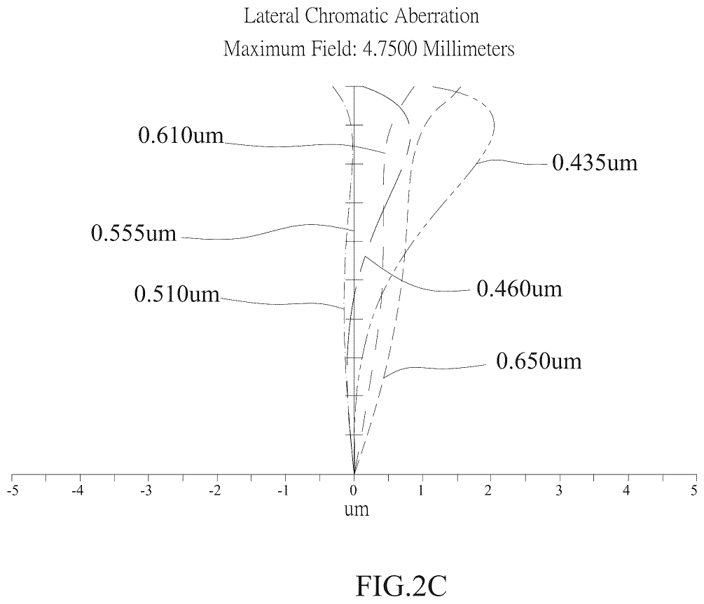

An optical imaging lens 200 according to a second embodiment of the present invention is illustrated in FIG. 2A, which includes, in order along an optical axis Z from an object side to an image side, a first lens assembly G1, an aperture S6, and a second lens assembly G2. In the second embodiment, the optical imaging lens 200 includes at least seven lenses, wherein the first lens assembly G1 consists of, in order along the optical axis Z from the object side to the image side, a first lens L1, a second lens L2, and a third lens L3. The second lens assembly G2 consists of, in order along the optical axis Z from the object side to the image side, a fourth lens LA, a fifth lens L5, a sixth lens L6, and a seventh lens L7.

The first lens L1 has negative refractive power; an object-side surface S1 of the first lens L1 is a concave surface, and an image-side surface S2 of the first lens L1 is a convex surface; both of the object-side surface S1 and the image-side surface S2 of the first lens L1 are aspheric surfaces.

The second lens L2 has negative refractive power; an object-side surface S3 of the second lens L2 is a convex surface, and an image-side surface S4 of the second lens L2 is a concave surface; both of the object-side surface S3 and the image-side surface S4 of the second lens L2 are spherical surfaces.

The third lens L3 is a biconvex lens with positive refractive power, wherein both of an object-side surface S4 and an image-side surface S5 of the third lens L3 are spherical surfaces. In the second embodiment, the object-side surface S4 of the third lens L3 and the image-side surface S4 of the second lens L2 are adhered to form a compound lens having positive refractive power.

The fourth lens LA is a biconvex lens with positive refractive power, wherein both of an object-side surface S7 and an image-side surface S8 of the fourth lens LA are spherical surfaces.

The fifth lens L5 is a biconvex lens with positive refractive power, wherein both of an object-side surface S9 and an image-side surface S10 of the fifth lens L5 are spherical surfaces.

The sixth lens L6 is a biconcave lens with negative refractive power, wherein an object-side surface S10 of the sixth lens L6 is a spherical surface, and an image-side S11 of the sixth lens L6 is an aspheric surface. In the second embodiment, the object-side surface S10 of the sixth lens L6 and the image-side surface S10 of the fifth lens L5 are adhered to form a compound lens having negative refractive power.

The seventh lens L7 has positive refractive power; an object-side surface S12 of the seventh lens L7 is a convex surface, and an image-side surface S13 of the seventh lens L7 is a concave surface; the object-side surface S12 of the seventh lens L7 is an aspheric surface, and the image-side surface S13 of the seventh lens L7 is a spherical surface.

Additionally, the optical imaging lens 200 further includes an infrared filter L8 and a protective glass L9, wherein the infrared filter L8 forms an object-side surface S14 facing the object side and an image-side surface S15 facing the image side. The infrared filter L8 is disposed on one side of the image-side surface S13 of the seventh lens L7, thereby restricting infrared rays passing through the optical imaging lens 200 to improve the quality and fidelity of the image. The protective glass L9 forms an object-side surface S16 facing the object side and an image-side surface S17 facing the image side. The protective glass L9 is disposed on one side of the infrared filter L8 and is located between the infrared filter L8 and an image plane Im to protect the infrared filter L8.

In order to keep the optical imaging lens 200 in good optical performance and high imaging quality, in the second embodiment, the optical imaging lens 200 satisfies:

$$- 0.459 < F / f 1 < - 0.435 ; \qquad ( 1 )$$

$$- 0.385 < F / f 2 < - 0.362 ; \qquad ( 2 )$$

$$1. < F / f 3 < 1.2 ; \qquad ( 3 )$$

$$0.6 < F / f 4 < 0.8 ; \qquad ( 4 )$$

$$1.155 < F / f 5 < 1.205 ; \qquad ( 5 )$$

$$- 2.523 < F / f 6 < - 2.412 ; \qquad ( 6 )$$

$$0.249 < F / f 7 < 0.286 ; \qquad ( 7 )$$

$$0.455 < F / fg 1 < 0.471 ; \qquad ( 8 )$$

$$0.335 < F / fg 2 < 0.367 . \qquad ( 9 )$$

wherein F is a focal length of the optical imaging lens 200; f1 is a focal length of the first lens L1; f2 is a focal length of the second lens L2; f3 is a focal length of the third lens L3; f4 is a focal length of the fourth lens L4; f5 is a focal length of the fifth lens L5; f6 is a focal length of the sixth lens L6; f7 is a focal length of the seventh lens L7; fg1 is a focal length of the first lens assembly G1; fg2 is a focal length of the second lens assembly G2.

Parameters of the optical imaging lens 200 of the second embodiment of the present invention are listed in following Table 3, including the focal length F of the optical imaging lens 200 (also called an effective focal length (EFL)), a F-number (Fno), a maximal field of view (FOV), a radius of curvature (R) of each lens, a distance (D) between each surface and the next surface on the optical axis Z, a refractive index (Nd) of each lens, an Abbe number (Vd) of each lens, the focal length of each lens, wherein a unit of the focal length, the radius of curvature, and the distance is millimeter (mm). The data listed below are not a limitation of the present invention, wherein the parameters that could be appropriate changed by one with ordinary skill in the art after referring the present invention should still fall within the scope of the present invention.

TABLE 3
F = 14.84 mm; Fno = 1.62; FOV = 35.89 deg

| | | | | | | Cemented | | |
|---|---|---|---|---|---|---|---|---|
| | | | | | Focal | focal | Focal | |
| Surface | R(mm) | D(mm) | Nd | Vd | length | length | length | Note |
| S1 | −10.210 | 3.212 | 1.808 | 40.549 | −34.051 | | 32.576 | First |
| | | | | | | | | lens L1 |
| S2 | −18.463 | 0.161 | | | | | | |
| S3 | 150.000 | 1.520 | 1.689 | 31.157 | −40.895 | 20.417 | | Second |
| | | | | | | | | lens L2 |
| S4 | 23.755 | 3.587 | 1.699 | 51.112 | 14.000 | | | Third |
| | | | | | | | | lens L3 |
| S5 | −15.728 | 0.053 | | | | | | |
| S6 | INFINITY | 1.940 | | | | | | Aperture |
| | | | | | | | | S6 |
| S7 | 131.000 | 3.117 | 1.648 | 53.024 | 21.876 | | 40.551 | Fourth |
| | | | | | | | | lens L4 |
| S8 | −15.831 | 0.150 | | | | | | |
| S9 | 15.377 | 3.225 | 1.699 | 51.112 | 12.833 | −18.553 | | Fifth |
| | | | | | | | | lens L5 |
| S10 | −19.886 | 3.023 | 1.689 | 31.157 | −6.150 | | | Sixth |
| | | | | | | | | lens L6 |
| S11 | 5.768 | 4.355 | | | | | | |
| S12 | 14.403 | 2.205 | 1.583 | 59.386 | 52.136 | | | Seventh |
| | | | | | | | | lens L7 |
| S13 | 25.740 | 2.401 | | | | | | |
| S14 | INFINITY | 0.400 | 1.517 | 64.167 | | | | Infrared |
| | | | | | | | | Filter L8 |
| S15 | INFINITY | 0.371 | | | | | | |
| S16 | INFINITY | 0.500 | 1.517 | 64.167 | | | | Protective |
| | | | | | | | | Glass L9 |
| S17 | INFINITY | 0.150 | | | | | | |
| Im | INFINITY | 0.000 | | | | | | Image |
| | | | | | | | | Plane Im |

It could be seen from Table 3 that, in the second embodiment, the focal length F of the optical imaging lens 200 is 14.84 mm, and the Fno is 1.62, and the FOV is 35.89 degrees, wherein the focal length f1 of the first lens L1 is −34.051 mm; the focal length f2 of the second lens L2 is −40.895 mm; the focal length f3 of the third lens L3 is 14.000 mm; the focal length f4 of the fourth lens LA is 21.876 mm; the focal length f5 of the fifth lens L5 is 12.833 mm; the focal length f6 of the sixth lens L6 is −6.150 mm; the focal length f7 of the seventh lens L7 is 52.136 mm; the focal length f23 (cemented focal length) of the compound lens formed by adhering the second lens L2 and the third lens L3 is 20.417 mm; the focal length f56 (cemented focal length) of the compound lens formed by adhering the fifth lens L5 and the sixth lens L6 is −18.553 mm; the focal length fg1 of the first lens assembly G1 is 32.576 mm; the focal length fg2 of the second lens assembly G2 is 40.551 mm.

Additionally, based on the above detailed parameters, detailed values of the aforementioned conditions (1) to (9) in the second embodiment are as follows:

$$F / f 1 = - 0.436 ; \qquad ( 1 )$$

$$F / f 2 = - 0.363 ; \qquad ( 2 )$$

$$F / f 3 = 1.06 ; \qquad ( 3 )$$

$$F / f 4 = 0.678 ; \qquad ( 4 )$$

$$F / f 5 = 1.156 ; \qquad ( 5 )$$

$$F / f 6 = - 2.413 ; \qquad ( 6 )$$

$$F / f 7 = 0.285 ; \qquad ( 7 )$$

$$F / fg 1 = 0.456 ; \qquad ( 8 )$$

$$F / fg 2 = 0.366 . \qquad ( 9 )$$

With the parameters from Table 3, in the second embodiment, the focal length of each lens, the focal length fg1 of the first lens assembly G1, and the focal length fg2 of the second lens assembly G2 satisfy the aforementioned conditions (1) to (9) of the optical imaging lens 200.

Additionally, in the second embodiment, the optical imaging lens 200 further satisfies:

$$0.9 < F / R 9 < 1.1 ; \qquad ( 10 )$$

$$2.5 < F / R 11 < 2.7 ; \qquad ( 11 )$$

$$0.104 < fg 1 / ( R 1 + R 2 + R 3 + R 4 + R 5 + R 7 + R 8 + R 9 + R 10 + R 11 + R 12 + R 13 ) < 0.115 ; \qquad ( 12 )$$

$$0.141 < fg 2 / ( R 1 + R 2 + R 3 + R 4 + R 5 + R 7 + R 8 + R 9 + R 10 + R 11 + R 12 + R 13 ) < 0.148 ; \qquad ( 13 )$$

$$0.048 < F / ( R 1 + R 2 + R 3 + R 4 + R 5 + R 7 + R 8 + R 9 + R 10 + R 11 + R 12 + R 13 ) < 0.053 ; \qquad ( 14 )$$

wherein F is the focal length of the optical imaging lens 200; R1 is a radius of curvature of the object-side surface S1 of the first lens L1; R2 is a radius of curvature of the image-side surface S2 of the first lens L1; R3 is a radius of curvature of the object-side surface S3 of the second lens L2; R4 is a radius of curvature of a surface formed by correspondingly adhering the image-side surface S4 of the second lens L2 and the object-side surface S4 of the third lens L3; R5 is a radius of curvature of the image-side surface S5 of the third lens L3; R7 is a radius of curvature of the object-side surface S7 of the fourth lens LA; R8 is a radius of curvature of the image-side surface S8 of the fourth lens LA; R9 is a radius of curvature of the object-side surface S9 of the fifth lens L5; R10 is a radius of curvature of a surface formed by correspondingly adhering the image-side surface S10 of the fifth lens L5 and the object-side surface S10 of the sixth lens L6; R11 is a radius of curvature of the image-side surface S11 of the sixth lens L6; R12 is a radius of curvature of the object-side surface S12 of the seventh lens L7; R13 is a radius of curvature of the image-side surface S13 of the seventh lens L7; fg1 is the focal length of the first lens assembly G1; fg2 is the focal length of the second lens assembly G2.

Based on the detailed parameters of Table 3, detailed values of the aforementioned conditions (10) to (14) in the second embodiment are as follows:

$$F / R 9 = 0.965 ; \qquad ( 10 )$$

$$F / R 11 = 2.573 ; \qquad ( 11 )$$

$$fg 1 / ( R 1 + R 2 + R 3 + R 4 + R 5 + R 7 + R 8 + R 9 + R 10 + R 11 + R 12 + R 13 ) = 0.114 ; \qquad ( 12 )$$

$$fg 2 / ( R 1 + R 2 + R 3 + R 4 + R 5 + R 7 + R 8 + R 9 + R 10 + R 11 + R 12 + R 13 ) = 0.142 ; \qquad ( 13 )$$

$$F / ( R 1 + R 2 + R 3 + R 4 + R 5 + R 7 + R 8 + R 9 + R 10 + R 11 + R 12 + R 13 ) = 0.052 . \qquad ( 14 )$$

With the parameters from Table 3, each of the related values in the second embodiment satisfies the aforementioned conditions (10) to (14) of the optical imaging lens 200.

Moreover, an aspheric surface contour shape Z of each of the object-side surface S1 of the first lens L1, the image-side surface S2 of the first lens L1, the image-side surface S11 of the sixth lens L6, and the object-side surface S12 of the seventh lens L7 according to the second embodiment could be obtained by following formula:

$$Z = \frac{{ch}^{2}}{1 + \sqrt{1 - ( 1 + k ) {c}^{2} {h}^{2}}} + {A}_{2} {h}^{2} + {A}_{4} {h}^{4} + {A}_{6} {h}^{6} + {A}_{8} {h}^{8} + {A}_{10} {h}^{10} + {A}_{12} {h}^{12} + {A}_{14} {h}^{14} + {A}_{16} {h}^{16}$$

wherein Z is aspheric surface contour shape; c is reciprocal of radius of curvature; h is half the off-axis height of the surface; k is conic constant; A2, A4, A6, A8, A10, A12, and A14 respectively represents different order coefficient of h.

In the optical imaging lens 200 according to the second embodiment, the conic constant k of each of the aspheric surfaces and the different order coefficient of A2, A4, A6, A8, A10, A12, A14, and A16 are listed in following Table 4:

TABLE 4

| Surface | S1 | S2 | S11 | S12 |
|---|---|---|---|---|
| k | −8.14585E−01 | −3.99573E+00 | 6.22554E+00 | 2.86567E+01 |
| A2 | 0 | 0 | 0 | 0 |
| A4 | 6.87949E−05 | 2.05491E−04 | 5.15340E−04 | 6.35954E−04 |
| A6 | 3.55395E−06 | 2.99647E−06 | 8.89619E−07 | −2.1825E−05 |
| A8 | −7.43748E−08 | −2.20033E−08 | −3.94246E−07 | 4.11895E−06 |
| A10 | 1.27168E−09 | 0 | 8.27014E−08 | −5.14614E−07 |
| A12 | −4.29521E−11 | 0 | −4.8028E−09 | 4.09794E−08 |
| A14 | 8.62501E−13 | 0 | 1.33613E−10 | −1.69393E−09 |
| A16 | −6.61054E−15 | 0 | −1.20292E−12 | 2.95791E−11 |

Taking optical simulation data to verify the imaging quality of the optical imaging lens 200, wherein FIG. 2B is a diagram showing the longitudinal chromatic aberration according to the second embodiment. From FIG. 2B, it could be observed that the curves formed by each wavelength are close to one another, thereby significantly enhancing chromatic aberration. The skewness of each curve shows that the deviation of the imaging points of off-axis rays is controlled within the range of −0.01 to 0.05 millimeters. Therefore, in the second embodiment, chromatic aberration for different wavelengths is significantly improved.

The lateral chromatic aberration according to the second embodiment is illustrated in FIG. 2C. From FIG. 2C, it could be observed that the lateral chromatic aberration of both the shortest wavelength and the longest wavelength irradiating on the image plane is less than 2.5 micrometers, indicating that the optical imaging lens 200 has low lateral chromatic aberration. The rays of different wavelengths tend to converge at the image plane, thereby improving color accuracy and image quality.

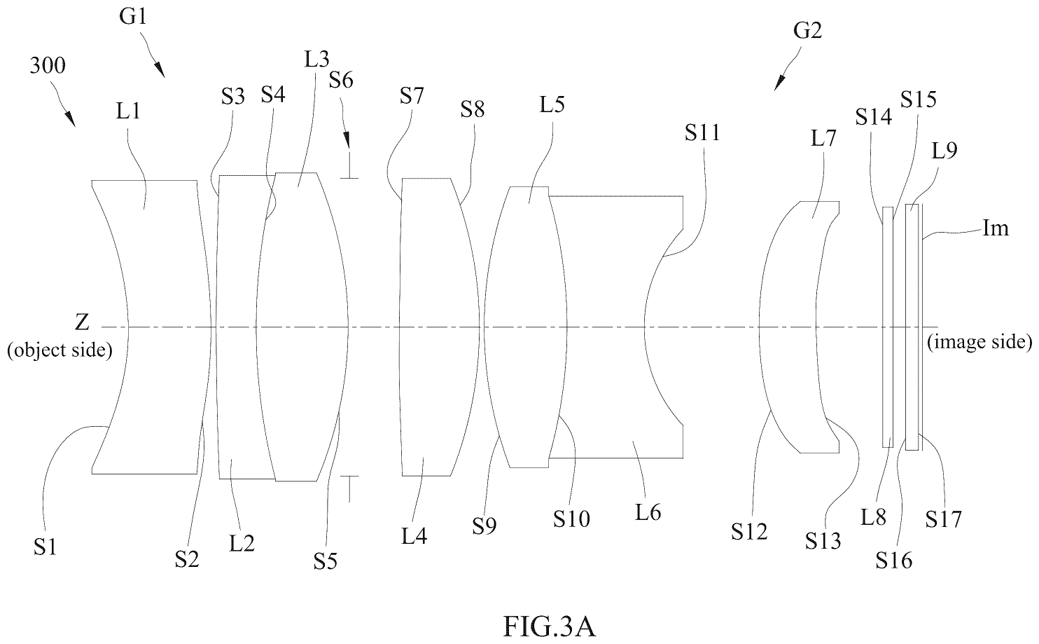

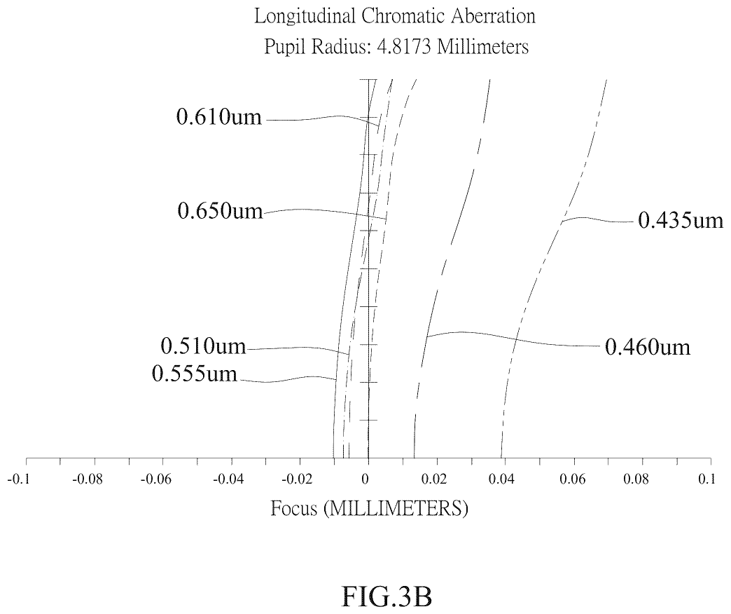

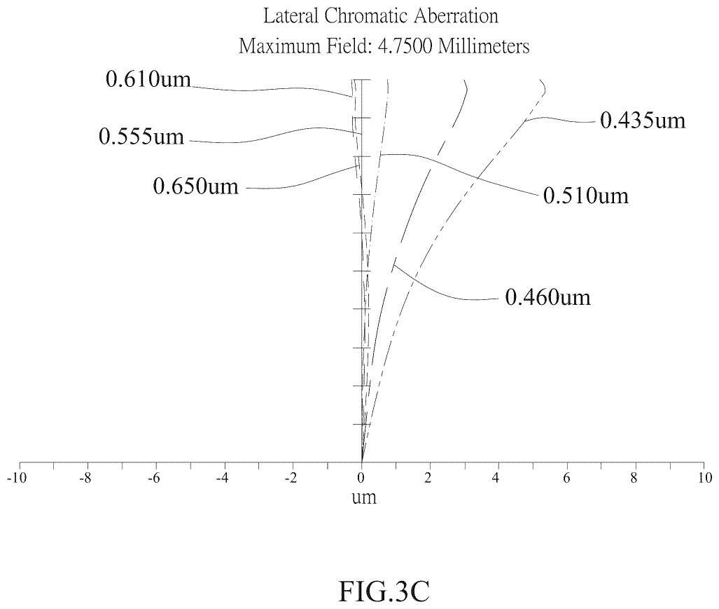

An optical imaging lens 300 according to a third embodiment of the present invention is illustrated in FIG. 3A, which includes, in order along an optical axis Z from an object side to an image side, a first lens assembly G1, an aperture S6, and a second lens assembly G2. In the third embodiment, the optical imaging lens 300 includes at least seven lenses, wherein the first lens assembly G1 consists of, in order along the optical axis Z from the object side to the image side, a first lens L1, a second lens L2, and a third lens L3. The second lens assembly G2 consists of, in order along the optical axis Z from the object side to the image side, a fourth lens LA, a fifth lens L5, a sixth lens L6, and a seventh lens L7.

The first lens L1 has negative refractive power; an object-side surface S1 of the first lens L1 is a concave surface, and an image-side surface S2 of the first lens L1 is a convex surface; both of the object-side surface S1 and the image-side surface S2 of the first lens L1 are aspheric surfaces.

The second lens L2 has negative refractive power; an object-side surface S3 of the second lens L2 is a convex surface, and an image-side surface S4 of the second lens L2 is a concave surface; both of the object-side surface S3 and the image-side surface S4 of the second lens L2 are spherical surfaces.

The third lens L3 is a biconvex lens with positive refractive power, wherein both of an object-side surface S4 and an image-side surface S5 of the third lens L3 are spherical surfaces. In the third embodiment, the object-side surface S4 of the third lens L3 and the image-side surface S4 of the second lens L2 are adhered to form a compound lens having positive refractive power.

The fourth lens LA is a biconvex lens with positive refractive power, wherein both of an object-side surface S7 and an image-side surface S8 of the fourth lens LA are spherical surfaces.

The fifth lens L5 is a biconvex lens with positive refractive power, wherein both of an object-side surface S9 and an image-side surface S10 of the fifth lens L5 are spherical surfaces.

The sixth lens L6 is a biconcave lens with negative refractive power, wherein an object-side surface S10 of the sixth lens L6 is a spherical surface, and an image-side S11 of the sixth lens L6 is an aspheric surface. In the third embodiment, the object-side surface S10 of the sixth lens L6 and the image-side surface S10 of the fifth lens L5 are adhered to form a compound lens having negative refractive power.

The seventh lens L7 has positive refractive power; an object-side surface S12 of the seventh lens L7 is a convex surface, and an image-side surface S13 of the seventh lens L7 is a concave surface; the object-side surface S12 of the seventh lens L7 is an aspheric surface, and the image-side surface S13 of the seventh lens L7 is a spherical surface.

Additionally, the optical imaging lens 300 further includes an infrared filter L8 and a protective glass L9, wherein the infrared filter L8 forms an object-side surface S14 facing the object side and an image-side surface S15 facing the image side. The infrared filter L8 is disposed on one side of the image-side surface S13 of the seventh lens L7, thereby restricting infrared rays passing through the optical imaging lens 300 to improve the quality and fidelity of the image. The protective glass L9 forms an object-side surface S16 facing the object side and an image-side surface S17 facing the image side. The protective glass L9 is disposed on one side of the infrared filter L8 and is located between the infrared filter L8 and an image plane Im to protect the infrared filter L8.

In order to keep the optical imaging lens 300 in good optical performance and high imaging quality, in the third embodiment, the optical imaging lens 300 satisfies:

$$- 0.459 < F / f 1 < - 0.435 ; \qquad ( 1 )$$

$$- 0.385 < F / f 2 < - 0.362 ; \qquad ( 2 )$$

$$1. < F / f 3 < 1.2 ; \qquad ( 3 )$$

$$0.6 < F / f 4 < 0.8 ; \qquad ( 4 )$$

$$1.155 < F / f 5 < 1.205 ; \qquad ( 5 )$$

$$- 2.523 < F / f 6 < - 2.412 ; \qquad ( 6 )$$

$$0.249 < F / f 7 < 0.286 ; \qquad ( 7 )$$

$$0.455 < F / fg 1 < 0.471 ; \qquad ( 8 )$$

$$0.335 < F / fg 2 < 0.367 . \qquad ( 9 )$$

wherein F is a focal length of the optical imaging lens 300; f1 is a focal length of the first lens L1; f2 is a focal length of the second lens L2; f3 is a focal length of the third lens L3; f4 is a focal length of the fourth lens LA; f5 is a focal length of the fifth lens L5; f6is a focal length of the sixth lens L6; f7 is a focal length of the seventh lens L7; fg1 is a focal length of the first lens assembly G1; fg2 is a focal length of the second lens assembly G2.

Parameters of the optical imaging lens 300 of the third embodiment of the present invention are listed in following Table 5, including the focal length F of the optical imaging lens 300 (also called an effective focal length (EFL)), a F-number (Fno), a maximal field of view (FOV), a radius of curvature (R) of each lens, a distance (D) between each surface and the next surface on the optical axis Z, a refractive index (Nd) of each lens, an Abbe number (Vd) of each lens, the focal length of each lens, wherein a unit of the focal length, the radius of curvature, and the distance is millimeter (mm). The data listed below are not a limitation of the present invention, wherein the parameters that could be appropriate changed by one with ordinary skill in the art after referring the present invention should still fall within the scope of the present invention.

TABLE 5
F = 15.50 mm; Fno = 1.70; FOV = 33.97 deg

| | | | | | | Cemented | | |
|---|---|---|---|---|---|---|---|---|
| | | | | | Focal | focal | Focal | |
| Surface | R(mm) | D(mm) | Nd | Vd | length | length | length | Note |
| S1 | −10.196 | 3.212 | 1.808 | 40.549 | −33.852 | | 32.958 | First |
| | | | | | | | | lens L1 |
| S2 | −18.481 | 0.161 | | | | | | |
| S3 | 160.328 | 1.520 | 1.689 | 31.157 | −40.394 | 20.523 | | Second |
| | | | | | | | | lens L2 |
| S4 | 23.757 | 3.587 | 1.699 | 51.112 | 14.000 | | | Third |
| | | | | | | | | lens L3 |
| S5 | −15.726 | 0.053 | | | | | | |
| S6 | INFINITY | 1.940 | | | | | | Aperture |
| | | | | | | | | S6 |
| S7 | 144.132 | 3.117 | 1.648 | 53.024 | 22.143 | | 46.090 | Fourth |
| | | | | | | | | lens L4 |
| S8 | −15.829 | 0.150 | | | | | | |
| S9 | 15.399 | 3.225 | 1.699 | 51.112 | 12.869 | −18.419 | | Fifth |
| | | | | | | | | lens L5 |
| S10 | −19.984 | 3.023 | 1.689 | 31.157 | −6.143 | | | Sixth |
| | | | | | | | | lens L6 |
| S11 | 5.751 | 4.355 | | | | | | |
| S12 | 14.721 | 2.205 | 1.517 | 64.167 | 62.096 | | | Seventh |
| | | | | | | | | lens L7 |
| S13 | 25.734 | 2.401 | | | | | | |
| S14 | INFINITY | 0.400 | 1.517 | 64.167 | | | | Infrared |
| | | | | | | | | Filter L8 |
| S15 | INFINITY | 0.371 | | | | | | |
| S16 | INFINITY | 0.500 | 1.517 | 64.167 | | | | Protective |
| | | | | | | | | Glass L9 |
| S17 | INFINITY | 0.150 | | | | | | |
| Im | INFINITY | 0.000 | | | | | | Image |
| | | | | | | | | Plane Im |

It could be seen from Table 5 that, in the third embodiment, the focal length F of the optical imaging lens 300 is 15.50 mm, and the Fno is 1.70, and the FOV is 33.97 degrees, wherein the focal length f1 of the first lens L1 is −33.852 mm; the focal length f2 of the second lens L2 is −40.394 mm; the focal length f3 of the third lens L3 is 14.000 mm; the focal length f4 of the fourth lens LA is 21.143 mm; the focal length f5 of the fifth lens L5 is 12.869 mm; the focal length f6 of the sixth lens L6 is −6.143 mm; the focal length f7 of the seventh lens L7 is 62.096 mm; the focal length f23 (cemented focal length) of the compound lens formed by adhering the second lens L2 and the third lens L3 is 20.523 mm; the focal length f56 (cemented focal length) of the compound lens formed by adhering the fifth lens L5 and the sixth lens L6 is −18.419 mm; the focal length fg1 of the first lens assembly G1 is 32.958 mm; the focal length fg2 of the second lens assembly G2 is 46.090 mm.

Additionally, based on the above detailed parameters, detailed values of the aforementioned conditions (1) to (9) in the third embodiment are as follows:

$$F / f 1 = - 0.458 ; \qquad ( 1 )$$

$$F / f 2 = - 0.384 ; \qquad ( 2 )$$

$$F / f 3 = 1.107 ; \qquad ( 3 )$$

$$F / f 4 = 0.7 ; \qquad ( 4 )$$

$$F / f 5 = 1.204 ; \qquad ( 5 )$$

$$F / f 6 = - 2.522 ; \qquad ( 6 )$$

$$F / f 7 = 0.25 ; \qquad ( 7 )$$

$$F / fg 1 = 0.47 ; \qquad ( 8 )$$

$$F / fg 2 = 0.336 . \qquad ( 9 )$$

With the parameters from Table 5, in the third embodiment, the focal length of each lens, the focal length fg1 of the first lens assembly G1, and the focal length fg2 of the second lens assembly G2 satisfy the aforementioned conditions (1) to (9) of the optical imaging lens 300.

Additionally, in the third embodiment, the optical imaging lens 300 further satisfies:

$$0.9 < F / R 9 < 1.1 ; \qquad ( 10 )$$

$$2.5 < F / R 11 < 2.7 ; \qquad ( 11 )$$

$$0.104 < fg 1 / ( R 1 + R 2 + R 3 + R 4 + R 5 + R 7 + R 8 + R 9 + R 10 + R 11 + R 12 + R 13 ) < 0.115 ; \qquad ( 12 )$$

$$0.141 < fg 2 / ( R 1 + R 2 + R 3 + R 4 + R 5 + R 7 + R 8 + R 9 + R 10 + R 11 + R 12 + R 13 ) < 0.148 ; \qquad ( 13 )$$

$$0.048 < F / ( R 1 + R 2 + R 3 + R 4 + R 5 + R 7 + R 8 + R 9 + R 10 + R 11 + R 12 + R 13 ) < 0.053 ; \qquad ( 14 )$$

wherein F is the focal length of the optical imaging lens 300; R1 is a radius of curvature of the object-side surface S1 of the first lens L1; R2 is a radius of curvature of the image-side surface S2 of the first lens L1; R3 is a radius of curvature of the object-side surface S3 of the second lens L2; R4 is a radius of curvature of a surface formed by correspondingly adhering the image-side surface S4 of the second lens L2 and the object-side surface S4 of the third lens L3; R5 is a radius of curvature of the image-side surface S5 of the third lens L3; R7 is a radius of curvature of the object-side surface S7 of the fourth lens LA; R8 is a radius of curvature of the image-side surface S8 of the fourth lens LA; R9 is a radius of curvature of the object-side surface S9 of the fifth lens L5; R10 is a radius of curvature of a surface formed by correspondingly adhering the image-side surface S10 of the fifth lens L5 and the object-side surface S10 of the sixth lens L6; R11 is a radius of curvature of the image-side surface S11 of the sixth lens L6; R12 is a radius of curvature of the object-side surface S12 of the seventh lens L7; R13 is a radius of curvature of the image-side surface S13 of the seventh lens L7; fg1 is the focal length of the first lens assembly G1; fg2 is the focal length of the second lens assembly G2.

Based on the detailed parameters of Table 5, detailed values of the aforementioned conditions (10) to (14) in the third embodiment are as follows:

$$F / R 9 = 1.006 ; \qquad ( 10 )$$

$$F / R 11 = 2.694 ; \qquad ( 11 )$$

$$fg 1 / ( R 1 + R 2 + R 3 + R 4 + R 5 + R 7 + R 8 + R 9 + R 10 + R 11 + R 12 + R 13 ) = 0.105 ; \qquad ( 12 )$$

$$fg 2 / ( R 1 + R 2 + R 3 + R 4 + R 5 + R 7 + R 8 + R 9 + R 10 + R 11 + R 12 + R 13 ) = 0.147 ; \qquad ( 13 )$$

$$F / ( R 1 + R 2 + R 3 + R 4 + R 5 + R 7 + R 8 + R 9 + R 10 + R 11 + R 12 + R 13 ) = 0.049 . \qquad ( 14 )$$

With the parameters from Table 5, each of the related values in the third embodiment satisfies the aforementioned conditions (10) to (14) of the optical imaging lens 300.

Moreover, an aspheric surface contour shape Z of each of the object-side surface S1 of the first lens L1, the image-side surface S2 of the first lens L1, the image-side surface S11 of the sixth lens L6, and the object-side surface S12 of the seventh lens L7 according to the third embodiment could be obtained by following formula:

$$Z = \frac{{ch}^{2}}{1 + \sqrt{1 - ( 1 + k ) {c}^{2} {h}^{2}}} + {A}_{2} {h}^{2} + {A}_{4} {h}^{4} + {A}_{6} {h}^{6} + {A}_{8} {h}^{8} + {A}_{10} {h}^{10} + {A}_{12} {h}^{12} + {A}_{14} {h}^{14} + {A}_{16} {h}^{16}$$

wherein Z is aspheric surface contour shape; c is reciprocal of radius of curvature; h is half the off-axis height of the surface; k is conic constant; A2, A4, A6, A8, A10, A12, and A14 respectively represents different order coefficient of h.

In the optical imaging lens 300 according to the third embodiment, the conic constant k of each of the aspheric surfaces and the different order coefficient of A2, A4, A6, A8, A10, A12, A14, and A16 are listed in following Table 6:

TABLE 6

| Surface | S1 | S2 | S11 | S12 |
|---|---|---|---|---|
| k | −8.14585E−01 | −3.99573E+00 | 6.22554E+00 | 2.86567E+01 |
| A2 | 0 | 0 | 0 | 0 |
| A4 | 6.87949E−05 | 2.05491E−04 | 5.15340E−04 | 6.35954E−04 |
| A6 | 3.55395E−06 | 2.99647E−06 | 8.89619E−07 | −2.1825E−05 |
| A8 | −7.43748E−08 | −2.20033E−08 | −3.94246E−07 | 4.11895E−06 |
| A10 | 1.27168E−09 | 0 | 8.27014E−08 | −5.14614E−07 |
| A12 | −4.29521E−11 | 0 | −4.8028E−09 | 4.09794E−08 |
| A14 | 8.62501E−13 | 0 | 1.33613E−10 | −1.69393E−09 |
| A16 | −6.61054E−15 | 0 | −1.20292E−12 | 2.95791E−11 |

Taking optical simulation data to verify the imaging quality of the optical imaging lens 300, wherein FIG. 3B is a diagram showing the longitudinal chromatic aberration according to the third embodiment. From FIG. 3B, it could be observed that the curves formed by each wavelength are close to one another, thereby significantly enhancing chromatic aberration. The skewness of each curve shows that the deviation of the imaging points of off-axis rays is controlled within the range of −0.02 to 0.07 millimeters. Therefore, in the third embodiment, chromatic aberration for different wavelengths is significantly improved.

The lateral chromatic aberration according to the third embodiment is illustrated in FIG. 3C. From FIG. 3C, it could be observed that the lateral chromatic aberration of both the shortest wavelength and the longest wavelength irradiating on the image plane is less than 6 micrometers, indicating that the optical imaging lens 300 has low lateral chromatic aberration. The rays of different wavelengths tend to converge at the image plane, thereby improving color accuracy and image quality.

It must be pointed out that the embodiments described above are only some preferred embodiments of the present invention. It is noted that, the parameters listed in Tables are not a limitation of the present invention. All equivalent structures which employ the concepts disclosed in this specification and the appended claims should fall within the scope of the present invention.

What is claimed is:

1. An optical imaging lens, in order from an object side to an image side along an optical axis, comprising:
a first lens assembly consisting of, in order from the object side to the image side along the optical axis, a first lens having negative refractive power, a second lens having negative refractive power, and a third lens having positive refractive power, wherein an object-side surface of the first lens is a concave surface, and an image-side surface of the first lens is a convex surface;
an aperture;
a second lens assembly consisting of, in order from the object side to the image side along the optical axis, a fourth lens having positive refractive power, a fifth lens having positive refractive power, a sixth lens having negative refractive power, and a seventh lens having positive refractive power.

2. The optical imaging lens as claimed in claim 1, wherein an object-side surface of the second lens is a convex surface, and an image-side surface of the second lens is a concave surface; the third lens is a biconvex lens; the fourth lens is a biconvex lens; the fifth lens is a biconvex lens; the sixth lens is a biconcave lens; an object-side surface of the seventh lens is a convex surface, and an image-side surface of the seventh lens is a concave surface.

3. The optical imaging lens as claimed in claim 1, wherein the object-side surface and the image-side surface of the first lens are aspheric surfaces; an object-side surface and an image-side surface of the second lens are spherical surfaces; an object-side surface and an image-side surface of the third lens are spherical surfaces; an object-side surface and an image-side surface of the fourth lens are spherical surfaces; an object-side surface and an image-side surface of the fifth lens are spherical surfaces; an image-side surface of the sixth lens and an object-side surface of the seventh lens are aspheric surfaces.

4. The optical imaging lens as claimed in claim 1, wherein the optical imaging lens satisfies: 0.455<F/fg1<0.471, wherein F is a focal length of the optical imaging lens; fg1 is a focal length of the first lens assembly.

5. The optical imaging lens as claimed in claim 1, wherein the optical imaging lens satisfies: 0.335<F/fg2<0.367, wherein F is a focal length of the optical imaging lens; fg2 is a focal length of the second lens assembly.

6. The optical imaging lens as claimed in claim 1, wherein the optical imaging lens satisfies: 1.000<F/f3<1.200, wherein F is a focal length of the optical imaging lens; f3 is a focal length of the third lens.

7. The optical imaging lens as claimed in claim 1, wherein the optical imaging lens satisfies: 0.600<F/f4<0.800, wherein the F is a focal length of the optical imaging lens; f4 is a focal length of the fourth lens.

8. The optical imaging lens as claimed in claim 1, wherein the optical imaging lens satisfies: 0.900<F/R9<1.100, wherein the F is a focal length of the optical imaging lens; R9 is a radius of curvature of an object-side surface of the fifth lens.

9. The optical imaging lens as claimed in claim 1, wherein the optical imaging lens satisfies: 2.500<F/R11<2.700, wherein the F is a focal length of the optical imaging lens; R11 is a radius of curvature of an image-side surface of the sixth lens.

10. An optical imaging lens, in order from an object side to an image side along an optical axis, comprising:
a first lens assembly consisting of, in order from the object side to the image side along the optical axis, a first lens having negative refractive power, a second lens, and a third lens, wherein an object-side surface of the first lens is a concave surface, and an image-side surface of the first lens is a convex surface; an image-side surface of the second lens and an object-side surface of the third lens are adhered to form a compound lens having positive refractive power;
an aperture;
a second lens assembly consisting of, in order from the object side to the image side along the optical axis, a fourth lens having positive refractive power, a fifth lens, a sixth lens, and a seventh lens having positive refractive power, wherein an image-side surface of the fifth lens and an object-side surface of the sixth lens are adhered to form a compound lens having negative refractive power.

11. The optical imaging lens as claimed in claim 10, wherein an object-side surface of the second lens is a convex surface, and the image-side surface of the second lens is a concave surface; the third lens is a biconvex lens; the fourth lens is a biconvex lens; the fifth lens is a biconvex lens; the sixth lens is a biconcave lens; an object-side surface of the seventh lens is a convex surface, and an image-side surface of the seventh lens is a concave surface.

12. The optical imaging lens as claimed in claim 10, wherein the object-side surface and the image-side surface of the first lens are aspheric surfaces; an object-side surface and the image-side surface of the second lens are spherical surfaces; the object-side surface and an image-side surface of the third lens are spherical surfaces; an object-side surface and an image-side surface of the fourth lens are spherical surfaces; an object-side surface and the image-side surface of the fifth lens are spherical surfaces; an image-side surface of the sixth lens and an object-side surface of the seventh lens are aspheric surfaces.

13. The optical imaging lens as claimed in claim 10, wherein the optical imaging lens satisfies: 0.455<F/fg1<0.471, wherein F is a focal length of the optical imaging lens; fg1 is a focal length of the first lens assembly.

14. The optical imaging lens as claimed in claim 10, wherein the optical imaging lens satisfies: 0.335<F/fg2<0.367, wherein F is a focal length of the optical imaging lens; fg2 is a focal length of the second lens assembly.

15. The optical imaging lens as claimed in claim 10, wherein the optical imaging lens satisfies: 1.000<F/f3<1.200, wherein F is a focal length of the optical imaging lens; f3 is a focal length of the third lens.

16. The optical imaging lens as claimed in claim 10, wherein the optical imaging lens satisfies: 0.600<F/f4<0.800, wherein the F is a focal length of the optical imaging lens; f4 is a focal length of the fourth lens.

17. The optical imaging lens as claimed in claim 10, wherein the optical imaging lens satisfies: 0.900<F/R9<1.100, wherein the F is a focal length of the optical imaging lens; R9 is a radius of curvature of an object-side surface of the fifth lens.

18. The optical imaging lens as claimed in claim 10, wherein the optical imaging lens satisfies: 2.500<F/R11<2.700, wherein the F is a focal length of the optical imaging lens; R11 is a radius of curvature of an image-side surface of the sixth lens.

19. The optical imaging lens as claimed in claim 10, wherein the optical imaging lens satisfies: 0.104<fg1/(R1+R2+R3+R4+R5+R7+R8+R9+R10+R11+R12+R13)<0.115;
wherein fg1 is a focal length of the first lens assembly; R1 is a radius of curvature of the object-side surface of the first lens; R2 is a radius of curvature of the image-side surface of the first lens; R3 is a radius of curvature of an object-side surface of the second lens; R4 is a radius of curvature of a surface formed by correspondingly adhering the image-side surface of the second lens and the object-side surface of the third lens; R5 is a radius of curvature of an image-side surface of the third lens; R7 is a radius of curvature of an object-side surface of the fourth lens; R8 is a radius of curvature of an image-side surface of the fourth lens; R9 is a radius of curvature of an object-side surface of the fifth lens; R10 is a radius of curvature of a surface formed by correspondingly adhering the image-side surface of the fifth lens and the object-side surface of the sixth lens; R11 is a radius of curvature of an image-side surface of the sixth lens; R12 is a radius of curvature of an object-side surface of the seventh lens; R13 is a radius of curvature of an image-side surface of the seventh lens.

20. The optical imaging lens as claimed in claim 10, wherein the optical imaging lens satisfies: 0.141<fg2/(R1+R2+R3+R4+R5+R7+R8+R9+R10+R11+R12+R13)<0.148;
wherein fg2 is a focal length of the second lens assembly; R1 is a radius of curvature of the object-side surface of the first lens; R2 is a radius of curvature of the image-side surface of the first lens; R3 is a radius of curvature of an object-side surface of the second lens; R4 is a radius of curvature of a surface formed by correspondingly adhering the image-side surface of the second lens and the object-side surface of the third lens; R5 is a radius of curvature of an image-side surface of the third lens; R7 is a radius of curvature of an object-side surface of the fourth lens; R8 is a radius of curvature of an image-side surface of the fourth lens; R9 is a radius of curvature of an object-side surface of the fifth lens; R10 is a radius of curvature of a surface formed by correspondingly adhering the image-side surface of the fifth lens and the object-side surface of the sixth lens; R11 is a radius of curvature of an image-side surface of the sixth lens; R12 is a radius of curvature of an object-side surface of the seventh lens; R13 is a radius of curvature of an image-side surface of the seventh lens.

21. The optical imaging lens as claimed in claim 10, wherein the optical imaging lens satisfies: 0.048<F/(R1+R2+R3+R4+R5+R7+R8+R9+R10+R11+R12+R13)<0.053;
wherein F is a focal length of the optical imaging lens; R1 is a radius of curvature of the object-side surface of the first lens; R2 is a radius of curvature of the image-side surface of the first lens; R3 is a radius of curvature of an object-side surface of the second lens; R4 is a radius of curvature of a surface formed by correspondingly adhering the image-side surface of the second lens and the object-side surface of the third lens; R5 is a radius of curvature of an image-side surface of the third lens; R7 is a radius of curvature of an object-side surface of the fourth lens; R8 is a radius of curvature of an image-side surface of the fourth lens; R9 is a radius of curvature of an object-side surface of the fifth lens; R10 is a radius of curvature of a surface formed by correspondingly adhering the image-side surface of the fifth lens and the object-side surface of the sixth lens; R11 is a radius of curvature of an image-side surface of the sixth lens; R12 is a radius of curvature of an object-side surface of the seventh lens; R13 is a radius of curvature of an image-side surface of the seventh lens.
